(19) United States
(12) Patent Application Publication
(10) Pub. No.: US 2009/0277190 A1
(43) Pub. Date: Nov. 12, 2009

(54) Life-saving child car seat/carrier system designed to protect against passenger compartment temperature extremes

(76) Inventor: Christopher Michael Piette, Greenville, RI (US)

Correspondence Address: Christopher Michael Piette, 27 Steere Road, Greenville, RI, 02828, US

(21) Appl. No.: 12/387,619

(22) Filed: May 5, 2009

Related U.S. Application Data
(60) Provisional application No. 61/127,189, filed on May 10, 2008.

(51) Int. Cl. F25D 3/00; F25B 21/02; F25D 27/00; B60H 1/32; G01K 13/00; F25D 23/00

(52) U.S. Cl. 62/56; 62/3.2; 62/264; 62/244; 62/129; 62/259.3

(57) ABSTRACT

A life-saving child car seat/carrier safety system that protects a child from injury or death due to passenger compartment temperature extremes is described herein. Each year, children and infants die tragically as a result of overheating in automobile passenger compartments when they are mistakenly left unattended by their caregivers. The present invention provides a system and method for child safety comprising an automatically closing child car seat compartment that detects dangerous temperatures; notifies caregivers via an auto-dialing cell phone; alerts passersby via emergency lighting, audible alarms, vocal alerts, and electronic messaging; contacts emergency services with GPS location information; provides breathable air; and provides temperature regulation as needed to cool or warm a child. A distinguishing feature of the invention is lifesaving temperature regulation provided by a thermally insulating enclosable seating compartment, a temperature sensor, and a Peltier junction thermoelectric device, or other means of cooling and heating.

### CROSS-REFERENCE TO RELATED APPLICATIONS

This application claims the benefit of the provisional patent application of the same title, Ser. No. 61/127,189, filed on 10 May 2008 by the present inventor.

### FEDERALLY SPONSORED RESEARCH

Not Applicable

### SEQUENCE LISTING OR PROGRAM

Not Applicable

### FIELD OF THE INVENTION

This invention relates to child safety, specifically to an enclosable child car seat/carrier system that is designed to protect an unattended child against passenger compartment temperature extremes.

### BACKGROUND OF THE INVENTION

Each year, children and infants die tragically as a result of overheating in the passenger compartments of automobiles when they are mistakenly left unattended by their caregivers. Overstressed parents, forgetful grandparents, and inattentive caregivers can inadvertently forget that a child is in the car, and even on a relatively cool day, the passenger compartment temperature of an automobile can rise dramatically in a short amount of time. A need exists to develop a totally new child car seat/carrier that will provide protection against temperature extremes that occur inside enclosed automobiles.

Hyperthermia, which occurs when the human body absorbs more heat than it can dissipate, is the leading cause of non-traffic, stationary, automobile-related deaths in children under the age of fifteen. Even on a relatively comfortable day, the temperature in an enclosed vehicle may reach oven-like conditions of up to 180° F. depending on a variety of factors. In a study sponsored by Pediatrics Official Journal of the American Academy of Pediatrics, even on a seemingly mild 73° F. day, the passenger compartment temperature of an enclosed automobile can reach over 110° F. within 50 minutes.

Although it is a common assumption that leaving a car window slightly open will decrease the danger of overheating, the Pediatrics study concludes that this is not the case. After an hour, partially-open windows have little effect in reducing car temperature. Lowering a window as described in U.S. Pat. No. 6,345,767 B1 to Burrus IV, et al, 12 Feb. 2002 and U.S. Pat. No. 7,348,880 B2 to Hules, et al, 25 Mar. 2008, may not be sufficiently effective in reducing temperature. In addition, this may increase the risk of child abduction, precipitate vehicle security vulnerability, and rely on automobile systems and components to achieve safety.

U.S. Pat. No. 5,949,340 to Rossi, 28 Jul. 1998, and publication number 2007/0075575 A1 to Gregory II, et al, 5 Apr. 2007, describe inventions that activate a vehicle's air conditioning system to cool an unattended child. This requires engine activation in order to power the air conditioning. An unattended vehicle with a running engine is a target for theft, which may pose a safety problem for an unattended child. Additionally, this prior art relies on automobile systems and components to achieve safety.

The tragic loss of a child can be further compounded by legal consequences. According to a national study conducted by the Department of Geosciences, San Francisco State University, charges were filed in 49% of deaths by hyperthermia, and 81% of those charged were convicted. In cases involving paid caregivers (i.e., childcare workers, babysitters), charges were filed in 84% of deaths by hyperthermia, and 96% of those charged were convicted. Only 7% of the cases involved drugs or alcohol.

A solution, which has not been described in prior art, is a portable, self-contained, autonomous, automatically enclosing child protection system. Useful as both a child car seat and a child carrier, it will protect a child against extreme temperatures by automatic temperature control, while alerting caregivers, passersby, and rescue services.

### SUMMARY OF THE INVENTION

The invention, comprising an enclosable child car seat/carrier system, automatically detects dangerous temperatures; notifies caregivers via an auto-dialing cell phone or other means; alerts passersby via flashing lighting, alarms, vocal alerts, and electronic messaging; contacts emergency services such as 911; provides GPS location information; and, most importantly, provides temperature regulation as needed to cool or warm a child.

A distinguishing feature of the invention is lifesaving temperature regulation provided by a thermally-insulated, enclosable seating compartment, a temperature sensor, and a Peltier junction-based thermoelectric cooling (TEC) device, or other form(s) of cooling and heating.

A high impact-resistant thermally insulating housing provides an enclosable seating compartment environment with an automatically closing access hatch. Together they maximize cooling or heating by means of a Peltierjunction thermoelectric device or other form(s) of cooling/heating. The access hatch is normally open for child entry and exit. The high impact-resistant thermally insulating housing also serves to protect a child against impact injury in a motor vehicle or other accident.

This portable, self-contained, autonomous child protection system, useful as both a child car seat and a child carrier, protects a child against extreme temperatures and impact injury. Additionally, the invention may be easily removable from a vehicle and used as a child carrier outside of the vehicle, for example, on a hot day at a theme park.

The invention protects a child from injury or death as a result of hyperthermia brought about by high temperatures in an automobile passenger compartment, or hypothermia resulting from being left unattended in an automobile exposed to cold weather conditions. The thermally insulating, temperature-regulated, enclosed capsule creates an environment that increases the window of time during which the endangered child may be rescued.

### BRIEF DESCRIPTION OF THE DRAWINGS

FIG. 1 is a front view illustration of an embodiment of the present invention.

FIG. 2 is a cross-sectional view of an embodiment of a thermally insulating housing of the present invention.

FIG. 3 is a front view illustration of an embodiment of an under-hood RF link receiver of the present invention.

FIG. 4 is a functional block diagram of electrical, electronic, and electromechanical components of an embodiment of the present invention.

### DETAILED DESCRIPTION OF THE INVENTION

Described herein is a life-saving child car seat/carrier safety system designed to protect a child from injury or death due to passenger compartment temperature extremes.

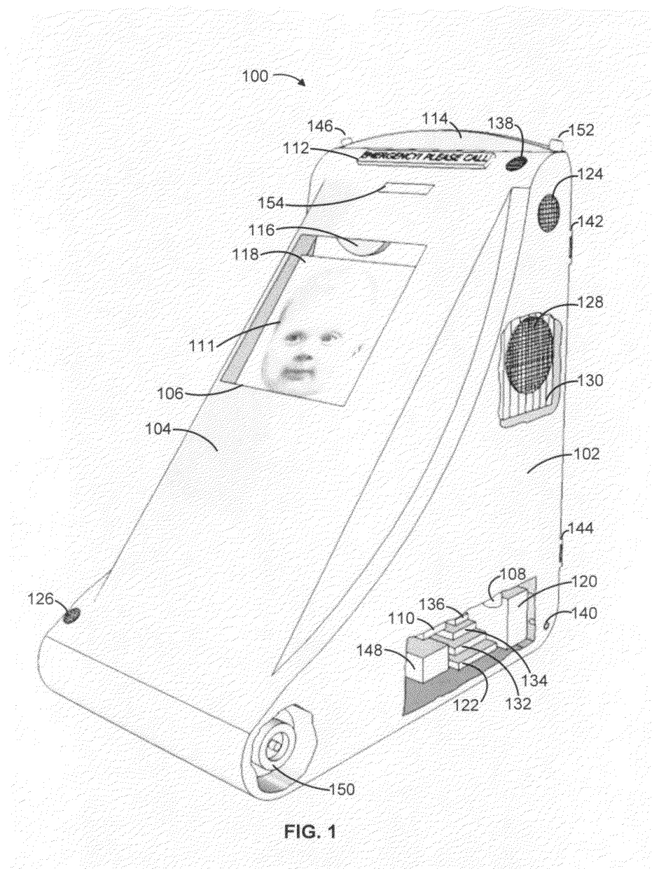

FIG. 1 is a front view illustration of an embodiment of the present invention 100. A thermally insulating housing 102 comprises the exterior of the present invention 100, forming an enclosable seating compartment 118 with a child restraint and an automatically closing access hatch 104.

The present invention's 100 access hatch 104 is shown in its closed position. The access hatch 104 is open during normal conditions, but closes in order to protect a seated child 111 when subjected to temperature extremes. The access hatch 104 may be manually opened by a handle 154 on the exterior of the hatch.

A viewing window 106 and interior lighting 116 allow passersby and rescue personnel to easily see the child 111 in the enclosable seating compartment 118, regardless of ambient lighting conditions.

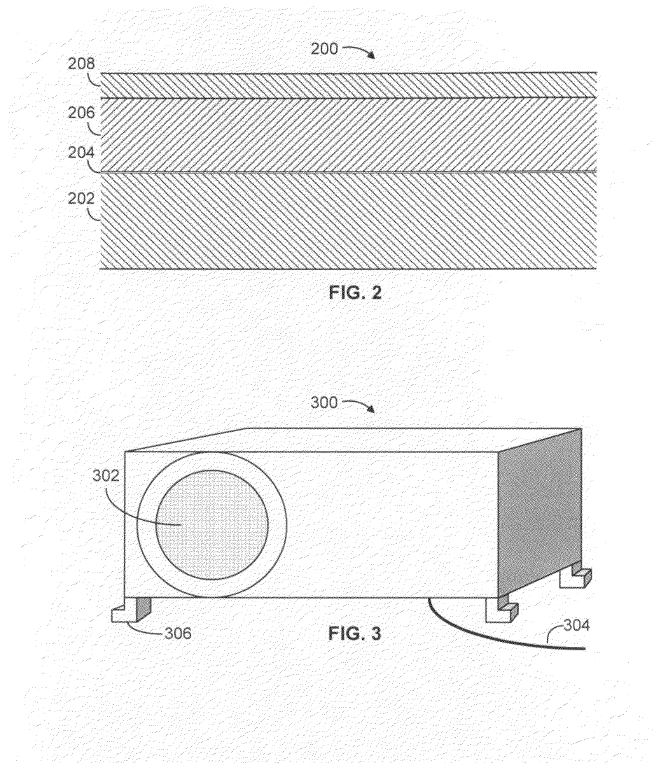

FIG. 2 is a cross-sectional view of an embodiment of a thermally insulating housing 102 that encapsulates a child 111 within the present invention 100. The housing 102 is a lamination of an exterior layer of high-impact plastic 202, similar to that found in safety helmets, bonded to a radiant barrier-quality reflective foil 204, bonded to a high R-value thermal insulation 206, bonded to an interior layer of plastic 208.

Referring to FIG. 1, an occupant sensor 110 detects the presence of a child 111 placed within the enclosable seating compartment 118. This initiates a self-test sequence within control logic 122 and powers up the present invention 100.

A temperature sensor 108 monitors the temperature to which the child 111 is subjected. Since the access hatch 104 is open during normal conditions, the temperature sensor 108 monitors the ambient temperature in the vehicle's passenger compartment. If the temperature exceeds a preset moderately-high temperature, the control logic 122 will initiate a number of simultaneous events described below.

A notification system comprising an auto-dial cell phone 132, emergency flashing lighting 114, an audible alarm and a vocal alert emitted from a loudspeaker 124, an RF link transmitter 134, an under-hood RF link receiver with an audible alarm and vocal alert 300, and an electronic message display 112 is activated.

The auto-dial cell phone 132 transmits text and voice messages to the child's 111 caregivers, the emergency flashing lighting 114 activates, the audible alarm and vocal alert are alternately emitted from the loudspeaker 124, and the electronic message display 112 scrolls an emergency message with contact names and phone numbers.

Also at this time, the RF link transmitter 134 transmits an activation signal to the under-hood RF link receiver 300 which alternately emits the under-hood audible alarm and vocal alert from a loudspeaker 302.

FIG. 3 is a front view illustration of an embodiment of the under-hood RF link receiver 300. When the RF link receiver 300 is activated by the RF link transmitter 134, the under-hood audible alarm and vocal alert are alternately emitted from the loudspeaker 302. The RF link receiver 300 is installed via mounting brackets 306 inside an automobile's engine compartment and connected to the automobile's battery via a cable 304.

If the child 111 is not removed from the dangerous condition, and if the temperature sensor 108 detects an increase in temperature that exceeds a preset life-threateningly high temperature, the control logic 122 will initiate a number of simultaneous events described below.

An access hatch closure mechanism 150 closes the access hatch 104, thereby enclosing the seating compartment 118; interior lighting 116 illuminates; breathing air is drawn in through an air intake port 126, circulated by low pressure ventilation control 148 through the enclosed seating compartment 118 and output through an air exhaust port 138; the auto-dial cell phone 132 calls emergency rescue services with a pre-recorded message and GPS coordinates; and an optional OnStar™ notification is initiated by an OnStar™ interface 136.

Also at this time, a temperature regulation system, comprising the temperature sensor 108 and a Peltier junction thermoelectric cooling module 130, is activated. The Peltier junction thermoelectric cooling (TEC) module 130 begins cooling the now-enclosed seating compartment 118. The temperature sensor 108 monitors the temperature inside the enclosed seating compartment 118, and, together with the control logic 122, manages the operation of the TEC module 130 to regulate the temperature inside the seating compartment 118. Waste heat from the TEC module 130 is vented out of a TEC exhaust fan port 128.

Those of ordinary skill in the art are familiar with the construction of cooling/heating modules utilizing a thermoelectric cooling device. This is a semiconductor device known by other names including Peltier junction, thermoelectric cooler, thermoelectric device, thermoelectric heat pump, solid-sate heat pump, Peltier diode, and Peltier device.

A thermoelectric cooling device provides cooling on one side of a Peltier junction and heat output on the opposite side when electric current is applied to the TEC. Reversing the direction of current flow through a TEC will cause the heating and cooling sides to reverse, thus simplifying construction of a combination heating/cooling unit.

TEC devices are commonly employed in solid state refrigerators, 12 volt portable food and beverage coolers/warmers (travel coolers), 12 volt refrigerators, and CPU coolers. Examples of embodiments of TEC module construction may be found in inexpensive 12 volt portable travel coolers.

Referring to FIG. 1, the child 111 is now protected within the enclosed seating compartment 118 with the access hatch 104 closed, is visible through the viewing window 106, is illuminated by the interior lighting 116, and is breathing air supplied by the ventilation control 148.

The temperature regulation system, comprising the temperature sensor 108 and the thermoelectric cooling module 130, cools the child 111, while the auto-dial cell phone 132 dials emergency services and the optional OnStar™ interface 136 initiates a call to OnStar™. The flashing lighting 114, audible alarms and vocal alerts 124 and 302, and the electronic message display 112 continue to operate until help arrives.

The temperature regulation system, together with the thermally insulating housing 102 surrounding the enclosed seating compartment 118, provides temperature control/thermal management to protect an unattended child 111 from dangerous temperatures inside a vehicle's passenger compartment.

If a child is left unattended in an automobile exposed to cold weather conditions, the present invention 100 will operate in a nearly identical manner. However, it will provide heat, rather than cooling, to protect the child 111 when the temperature inside the vehicle's passenger compartment drops below a preset life-threateningly low temperature. Reversing the direction of current flow through the thermoelectric cooling module 130 will reverse the operation of the TEC module 130, thus providing heat within the enclosed seating compartment 118.

The present invention 100 is securely fastened inside an automobile in a conventional manner, via safety seat belts fastened to belt loops 142 and 144.

The present invention 100 is portable and easily removed from an automobile for use in harsh temperature conditions, as might be experienced at a theme park or other outdoor venue. The RF link transmitter 134 is a low-power device and limited to operation within approximately 20 feet of the under-hood RF link receiver 300, thus preventing an undesired alarm and vocal alert at the automobile.

The cell phone antenna 152 and RF link transmitter antenna 146 are mounted atop the present invention 100 for reliable communications.

A battery 120 is rechargeable through a battery charger jack 140, and provides an electrical power means. Alternate electrical power means include operation via an automobile battery or an external power source.

To accommodate growing children, size-accommodating inserts are fitted into the present invention.

The thermoelectric cooling module 130 may be replaced with other methods of cooling and/or heating, including, but not limited to, heat pumps, Carnot cycle cooling, vapor compression/absorption refrigeration cycles, magnetic field refrigeration, compressor-free cooling such as ferroelectric polymers, and other forms of electrical and mechanical cooling and heating.

### Operation of the Invention

During normal operation of the present invention 100, an access hatch 104 is open and a child 111 is placed inside an enclosable seating compartment 118. An occupant sensor 110 detects the presence of the child 111. This initiates control logic 122 system self-tests and battery 120 tests.

If the system tests or battery tests fail, the control logic 122 will sound warning beeps until the child 111 is removed from the present invention 100 or the fault is corrected.

If the system tests and battery tests pass, an electronic message display 112 will display “Self-Test Passed” and the present invention 100 will power up into a ready state.

A temperature sensor 108 monitors the temperature that the child 111 is subjected to. Since the access hatch 104 is open during normal conditions, the temperature sensor 108 monitors the ambient temperature in the vehicle's passenger compartment.

If the temperature exceeds a preset moderately-high temperature, the control logic 122 will activate a notification system comprising an auto-dial cell phone 132, emergency flashing lighting 114, an audible alarm and a vocal alert emitted from a loudspeaker 124, an RF link transmitter 134, an under-hood RF link receiver with an audible alarm and vocal alert 300, and an electronic message display 112.

The control logic 108 commands an auto-dial cell phone 132 to contact the child's 111 caregivers, activates emergency flashing lighting 114, initiates audible alarms and vocal alerts from loudspeakers 124 and 302, and displays an emergency message on an electronic message display 112.

If the temperature sensor 108 detects a temperature increase to a life-threateningly high level, the control logic 122 will activate an access hatch closure mechanism 150, enable interior lighting 116, initiate ventilation control 148 to provide breathable air, activate the auto-dial cell phone 132 to dial emergency services, and optionally initiate a call to OnStar™ via the OnStar™ interface 136.

Also at this time, a temperature regulation system, comprising the temperature sensor 108 and a thermoelectric cooling module 130, cools the child 111. The temperature sensor 108 monitors the temperature inside the now-enclosed seating compartment 118 and, together with the control logic 122, manages the operation of the thermoelectric cooling module 130 to regulate the temperature inside the enclosed seating compartment 118.

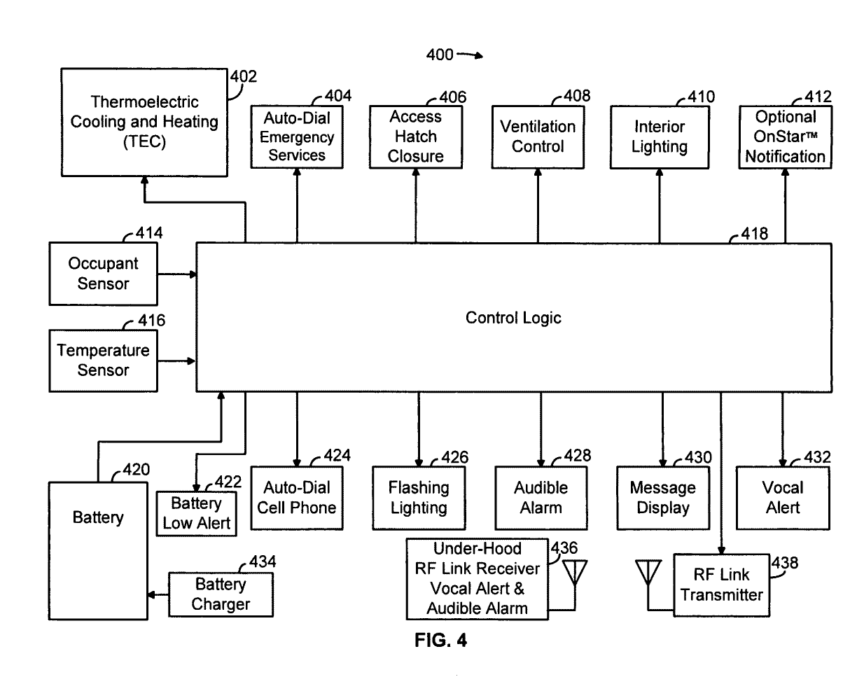

The functional block diagram of FIG. 4 illustrates electrical, electronic, and electromechanical components in an embodiment of the present invention 100.

An electrical power means includes a battery 420 that provides electrical power to the present invention 100 via control logic 418. A battery charger 434 recharges the battery 420, and a battery low alert 422 provides an audio warning indicating insufficient battery 420 capacity. Electrical power may also be provided externally.

An occupant sensor 414 detects the presence of a child 111 placed inside an enclosable seating compartment 118, and a temperature sensor 416 monitors the temperature that the child 111 is subjected to. Since an access hatch 104 is open during normal conditions, the temperature sensor 416 monitors the ambient temperature in the vehicle's passenger compartment. Both sensors 414 and 416 provide input to the control logic 418.

If the occupant sensor 414 detects the presence of a child 111 placed inside the enclosable seating compartment 118, it triggers the control logic 418 to run system self-tests and battery 420 tests.

If the system tests or battery tests fail, the control logic 418 will sound warning beeps until the child 111 is removed from the present invention 100 or the fault is corrected.

If the system self-tests and battery tests pass, an electronic message display 430 will display “Self-Test Passed” and the present invention 100 will power up into a ready state.

If the temperature sensor 416 detects a temperature that exceeds a preset moderately-high temperature, the control logic 418 will activate a notification system comprising an auto-dial cell phone 424, emergency flashing lighting 426, an audible alarm 428, a vocal alert 432, an RF link transmitter 438, an under-hood RF link receiver 436, and an electronic message display 430.

The control logic 418 commands the auto-dial cell phone 424 to contact the child's 111 caregivers, activate the emergency flashing lighting 426, initiate the audible alarm 428, and activate the vocal alert 432.

Furthermore, the control logic 418 activates an RF link transmitter 438 that activates an under-hood RF link receiver vocal alert and audible alarm 436, and displays an emergency message on the electronic message display 430.

If the child 111 is not removed from the dangerous temperature condition and if the temperature sensor 416 detects a temperature increase to a life-threateningly high level, the control logic 418 will activate an access hatch closure mechanism 406, enable interior lighting 410, initiate ventilation control 408 to provide breathing air, activate the auto-dial cell phone 404 to dial emergency services, and optionally initiate a call to OnStar™ via the OnStar™ interface 412.

Also at this time, a temperature regulation system, comprising the temperature sensor 416 and a thermoelectric cooling module 402, cools the child 111. The temperature sensor 416 monitors the temperature inside the now-enclosed seating compartment 118, and, together with the control logic 418, manages the operation of the thermoelectric cooling module 402 to regulate the temperature inside the seating compartment 118.

By providing an enclosed, temperature-regulated compartment, the present invention 100 creates a safe environment for a child inadvertently left unattended in an overheating or excessively cold car. This safe environment increases the window of time during which an endangered child may be rescued. Since minutes might mean the difference between life and death for an unattended child, the present invention 100 will save lives.

Although the above description and disclosure contains considerable detail, the described embodiments are to be considered in all respects only as illustrative and explanatory, rather than restricting or limiting, of the scope of the invention. A wide range of modifications and variations are possible within the scope and spirit of the appended claims and their legal equivalents.

What is claimed is:

1. An apparatus for protecting a child from passenger compartment temperature extremes, comprising:
a thermally insulating housing, forming an enclosable seating compartment, said enclosable seating compartment designed to receive and surround said child,
a temperature regulation system for controlling the temperature within said enclosable seating compartment,
a notification system for notifying others of said child's endangerment, electrical power means for providing electrical power to said apparatus.

2. The apparatus of claim 1, wherein said thermally insulating housing includes a lamination of an exterior layer of high-impact plastic, bonded to a radiant barrier-quality reflective foil, bonded to a high R-value thermal insulation, bonded to an interior layer of plastic.

3. The apparatus of claim 1, wherein said thermally insulating housing includes a viewing window and interior lighting, allowing passersby and rescue personnel to easily see said child in said enclosable seating compartment.

4. The apparatus of claim 1, wherein said enclosable seating compartment includes an occupant sensor for detecting the presence of said child.

5. The apparatus of claim 1, wherein said enclosable seating compartment includes an automatically closing access hatch.

6. The apparatus of claim 1, wherein said temperature regulating system includes a temperature sensor, and a temperature altering device selected from the group consisting of Peltier junction thermoelectric cooling, Carnot cycle cooling, heat pumps, vapor compression and absorption refrigeration cycles, magnetic field refrigeration, compressor-free cooling, ferroelectric polymer cooling, and electrical and mechanical cooling and heating.

7. The apparatus of claim 1, wherein said enclosable seating compartment includes ventilation control for providing breathable air to said child.

8. The apparatus of claim 1, wherein said notification system includes an auto-dialing cell phone, emergency flashing lighting, an audible alarm, a vocal alert, an under-hood audible alarm and vocal alert, and an electronic message display.

9. The apparatus of claim 1, wherein said thermally insulating housing is securely fastened inside an automobile in a conventional manner, via safety seat belts fastened to belt loops.

10. The apparatus of claim 1, wherein said apparatus is portable and easily removed from an automobile for use outside of said automobile.

11. The apparatus of claim 1, wherein said electrical power means is provided by a battery internal to said apparatus.

12. The apparatus of claim 1, wherein said electrical power means is provided by an electrical power source external to said apparatus.

13. A method for protecting a child from passenger compartment temperature extremes, comprising the steps of:
seating and restraining said child in an enclosable seating compartment,
insulating and surrounding said child in a thermally insulating housing, forming said enclosable seating compartment,
regulating temperature within said enclosable seating compartment,
notifying others of said child's endangerment.

14. The method of claim 13, wherein an occupant sensor detects the presence of said child in said enclosable seating compartment.

15. The method of claim 13, wherein said thermally insulating housing, forming said enclosable seating compartment, includes an automatically closing access hatch to enclose said child.

16. The method of claim 13, wherein breathable air is introduced into said enclosable seating compartment for said child.

17. The method of claim 13, wherein a temperature sensor and a temperature altering device regulate temperature in said enclosable seating compartment.

18. The method of claim 13, wherein caregivers, passersby, and rescue personnel are notified of said child's endangerment.

19. The method of claim 13, wherein said child in said enclosable seating compartment is visible through a viewing window and illuminated by interior lighting.

20. The method of claim 13, wherein said method creates a safe environment for said child by providing thermal insulation, temperature control, and breathable air in said enclosable seating compartment, and notifying people of said child's dangerous predicament, thereby protecting said child inadvertently left unattended in a vehicle's passenger compartment exposed to extreme temperature conditions.
